(19) United States
(12) Patent Application Publication
(10) Pub. No.: US 2025/0078035 A1
(43) Pub. Date: Mar. 6, 2025

(54) SYSTEMS AND METHODS FOR INTERACTING WITH WEB INTERFACES ON BEHALF OF USERS

(71) Applicant: SonicJobs App Ltd, London (GB)

(72) Inventors: Daniele Piras, Sestu (IT); Francesco Masia, Bosa (IT); Marco Zoncu, Lucca (IT); Ignacio Alonso, Valladolid (ES); Alessio Piucci, Fossacesia (IT); Riccardo Satta, Cagliari (IT); Nilesh Kathait, Indore (IN); Mikhil Raja, London (GB)

(21) Appl. No.: 18/458,795

(22) Filed: Aug. 30, 2023

(51) Int. Cl. G06Q 10/1053; G06F 11/07

(52) U.S. Cl. CPC G06Q 10/1053; G06F 11/0709; G06F 11/0793

(57) ABSTRACT

A component dedicated to service (e.g., website) interactions (interaction engine), a component dedicated to service analysis (content engine), and a component dedicated to error detection (error engine) communicate with each other to facilitate automatic interaction of the interaction engine with a service (e.g., a website). The interaction engine explores possible interactions with the service. The content engine performs analyses (e.g., textual, visual, voice-operated) of the service to understand the content offered and to determine actions for the content of the service. The interaction engine executes the actions for the content of the service. The error engine detects errors in interaction with the service and determines when required interactions with the service have not been performed. Cycles of content/action detection, error detection, and action execution are utilized to automatically interact with the service on behalf of the user.

### FIELD

The present disclosure relates generally to the field of interacting with web interfaces on behalf of users.

### BACKGROUND

A user may need to interact with a website to perform one or more actions. For example, a user may need to interact with a job website to submit a job application and while performing a job search, this may happen many times on multiple websites. Manually interacting with multiple websites to perform actions may be time consuming and cumbersome, which may reduce user engagement with the websites. For example, manually interacting with different job websites to submit different job applications may be time consuming and cumbersome. Time and effort required to interact with the websites may reduce the likelihood of job applicants filling out job applications and reduce the number of job applications that are completed, therefore reducing the chances of the user finding a job.

### SUMMARY

This disclosure relates to interacting with web interfaces on behalf of users. User information, content information, action information, and/or other information may be obtained. The user information may include information associated with user(s) for use in interacting with a website on behalf of the user(s). The content information for the website may define the content of the website. The content of the website may include elements of the website to be interacted with on behalf of the user(s). The action information for the website may define actions for the content of the website. The actions for the content of the website may define how the elements of the website are to be interacted with on behalf of the user(s). The actions for the content of the website may be executed based on the information associated with the user(s) and/or other information.

A system for interacting with web interfaces on behalf of users may include one or more electronic storage, one or more processors and/or other components. The electronic storage may store user information, information relating to a user, information relating to a website, content information, information relating to content of the website, action information, information relating to actions for the content of the website, information relating to execution of the actions for the content of the website, and/or other information.

The processor(s) may be configured by machine-readable instructions. Executing the machine-readable instructions may cause the processor(s) to facilitate interaction with web interfaces on behalf of users. The machine-readable instructions may include one or more computer program components. The computer program components may include one or more of a scrape component, a user component, a content component, an action component, an error component, an execution component, and/or other computer program components.

The scrape component may be configured to scrap the website. The scrape component may be configured to interact with the content of the website to determine possible interactions with the content of the website.

In some implementations, the website may include one or more webpages. The website may include one or more job application webpages. A job application webpage may include multiple fields to be completed by the user(s). Interacting with the website on behalf of the user(s) may include automatically completing the multiple fields of the job application webpage(s) on behalf of the user(s).

The user component may be configured to obtain user information and/or other information. The user information may include information associated with the user(s) for use in interacting with the website on behalf of the user(s).

In some implementations, the user component may be configured to request missing information from the user(s) for use in interacting with the website on behalf of the user(s).

The content component may be configured to obtain content information for the website and/or other information. The content information for the website may define content of the website. The content of the website may include elements of the website to be interacted with on behalf of the user(s). In some implementations, the elements of the website to be interacted with on behalf of the user(s) may include one or more text fields, one or more drop-down fields, one or more radio buttons, one or more checkboxes, one or more upload buttons, one or more action buttons, one or more input controls, and/or other elements.

The action component may be configured to obtain action information for the website and/or other information. The action information for the website may define actions for the content of the website. The actions for the content of the website may define how the elements of the website are to be interacted with on behalf of the user(s).

The error component may be configured to obtain error information for the website and/or other information. The error information for the website may define error status of the website. The error status of the website may include an unrecoverable error, a recoverable error, or other errors. Responsive to the error status of the website including the unrecoverable error, interaction with the website may be stopped.

The recoverable error may be associated with one or more network errors for the website. Responsive to the error status of the website including the recoverable error, one or more of the actions for the content of the website may be re-executed, one or more additional actions for the content of the website may be executed, and/or the website may be reloaded.

The recoverable error may be associated with one or more uncompleted parts of the content of the website. Responsive to the error status of the website including the recoverable error, one or more actions for the uncompleted part(s) of the content of the website may be executed.

The execution component may be configured to execute the actions for the content of the website. The actions for the content of the website may be executed based on the information associated with the user(s) and/or other information.

In some implementations, the execution component may be configured to change a form of the information associated with the user(s) for use in interacting with the website.

In some implementations, a user interaction with the website may be simulated in interacting with the website. Simulation of the user interaction with the website may include: use of a proxy and a DDOS protection bypass to interact with the website; modification of browser information and/or user information for interacting with the website; and/or use of delays in and/or between the execution of the actions for the content of the website.

In some implementations, one or more execution reports for the website may be generated. The execution report(s) may include information on interaction of the system with the website.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

FIG. 1 illustrates an example system for interacting with web interfaces on behalf of users.

FIG. 2 illustrates an example method for interacting with web interfaces on behalf of users.

FIG. 3 illustrates an example diagram of interaction between system components.

FIG. 4 illustrates an example process for automatically interacting with a website.

FIG. 5 illustrates an example cycle of a process for automatically interacting with a website.

FIG. 6 illustrates an example hierarchy of components for interacting with a website.

FIG. 7 illustrates example detections and actions for a webpage.

FIG. 8 illustrates example detections for a webpage.

FIG. 9 illustrates an example execution report for a webpage.

FIG. 10 illustrates an example visualization of interaction with a webpage.

### DETAILED DESCRIPTION

The present disclosure relates to interaction with web interfaces on behalf of users. A component dedicated to service (e.g., website) interactions (interaction engine), a component dedicated to service analysis (content engine), and a component dedicated to error detection (error engine) communicate with each other to facilitate automatic interaction of the interaction engine with a service (e.g., a website). The interaction engine explores possible interactions with the service. The content engine performs analyses (e.g., textual, visual, voice-operated) of the service to understand the content offered and to determine actions for the content of the service. The interaction engine executes the actions for the content of the service. The error engine detects errors in interaction with the service and determines when required interactions with the service have not been performed. Cycles of content/action detection, error detection, and action execution are utilized to automatically interact with the service on behalf of the user.

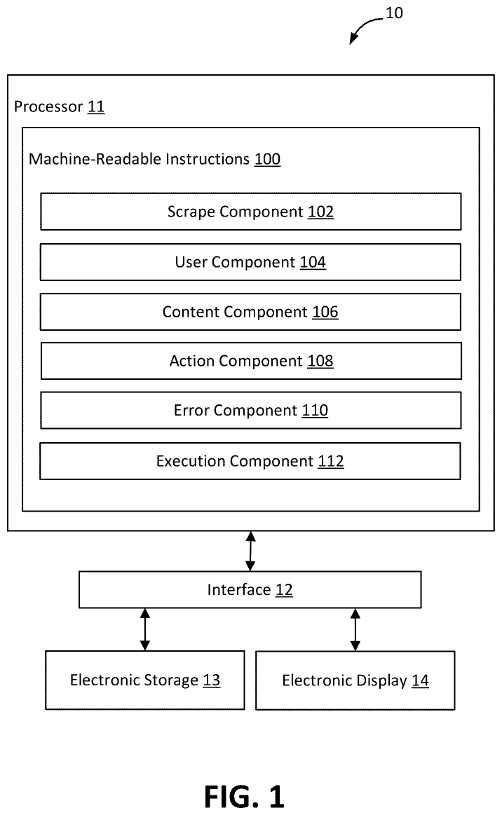

The methods and systems of the present disclosure may be implemented by a system and/or in a system, such as a system 10 shown in FIG. 1. The system 10 may include one or more of a processor 11, an interface 12 (e.g., bus, wireless interface), an electronic storage 13, an electronic display 14, and/or other components. User information, content information, action information, and/or other information may be obtained by the processor 11. The user information may include information associated with one or more users for use in interacting with the website on behalf of the user. The content information for the website may define the content of the website. The content of the website may include elements of the website to be interacted with on behalf of the user(s). The action information for the website may define actions for the content of the website. The actions for the content of the website may define how the elements of the website are to be interacted with on behalf of the user(s). The actions for the content of the website may be executed by the processor 11 based on the information associated with the user(s) and/or other information. The action for the content of the website may be executed on behalf of the user(s).

The electronic storage 13 may be configured to include one or more electronic storage media that electronically stores information. The electronic storage 13 may store software algorithms, information determined by the processor 11, information received remotely, and/or other information that enables the system 10 to function properly. For example, the electronic storage 13 may store user information, information relating to a user, information relating to a website, content information, information relating to content of the website, action information, information relating to actions for the content of the website, information relating to execution of the actions for the content of the website, and/or other information.

The electronic display 14 may refer to an electronic device that provides visual presentation of information. The electronic display 14 may include a color display and/or a non-color display. The electronic display 14 may be configured to visually present information. The electronic display 14 may present information using/within one or more graphical user interfaces. For example, the electronic display 14 may present user information, information relating to a user, information relating to a website, content information, information relating to content of the website, action information, information relating to actions for the content of the website, information relating to execution of the actions for the content of the website, and/or other information. The system 10 may include other user interface components, such as one or more voice-controlled interfaces.

A website includes one or more webpages. A user may interact with a website for a variety of reasons. A user may interact with a website to perform one or more actions, such as applying for a job, making a purchase, making a sale, searching for information, and/or other actions. A user may interact with a website to obtain information from the website and/or provide information to the website. For example, with respect to job applications, a user may interact with a website to obtain information on requirements for a job and/or to provide information about the user to apply for the job.

Time and effort required to interact with job websites to fill out job applications may discourage users (job candidates) from completing the job applications. For example, a user may search for job openings on a job aggregator website. Once a job is found, the user may start a job application process for the job. This action may result in the user being redirected to a job website from which the job originated. Every time the user arrives at a new job website, the user may need to navigate through the job website and provide their information (e.g., upload resume/CV, fill out/complete questionnaires/forms). The need to navigate through different job websites and repeatedly provide their information may discourage the user from completing job applications on job websites.

No standard format/process may exist to obtain information for job applications. Different job websites may require different user interaction to fill out job applications. For example, different job websites may have different webpage formatting, different navigation options, different information requests, and/or other differences in how a user needs to interact with the job website. Even with the same job, different job websites may require different user interaction to fill out job applications.

The differences between different job websites and differences between different job applications make automation of interacting with the job websites on behalf of users difficult. For example, for a particular job on a particular website, a process may be manually developed to interact with specific elements of the job website in a specific way to apply for the particular job. For instance, a person may click on specific buttons, select specific options, and/or insert specific information in specific fields to apply for the particular job, and the person's interaction with the elements of the job website may be recorded/duplicated for future use for the particular job. A script of interactions with specific buttons, options, and/or fields may be written to automate interaction for a particular job application. However, such automation of website interaction is not scalable. For example, such automation of website interaction may not be applicable to other job websites, other jobs, and/or other users. And if the website changes, previously defined automation may no longer work. Automation of interaction with websites provides both technical and resource challenges.

The present disclosure provides a solution to both technical and resource challenges in automating interaction with web interfaces. Interacting with web interfaces may refer to interacting with a website and vice versa. A web interface may refer to a user interface that is implemented in the form of a webpage. A web interface may refer to a user interface that may be navigated using a browser. A computing system automatically interacting with a website may include the computing system interacting with the website on behalf of users with little or no direct human control. A computing system automatically interacting with a website may include the computing system executing one or more actions on the website for a user so that the user need not perform the action(s) on the website. A computing system automatically interacting with a website may include the computing system executing one or more actions on the website for a user to relieve the user from the effort of interacting with the website. A computing system may automatically interact with a website on behalf of a user with the user's consent.

The present disclosure provides a tool to automatically interact with a website on behalf of a user. The tool executes actions for a website on behalf of a user. The tool includes interactions between a component dedicated to website interactions (interaction engine), a component dedicated to website analysis (content engine), and a component dedicated to error detection (error engine). The interaction engine interacts with the website to explore possible interactions with the website. Textual (e.g., source code, HTML), visual (e.g., screenshot), and/or audio (e.g., sound) information of the website are analyzed by the content engine to understand the content of the website and to determine actions for the content of the website. Error detection by the error engine is used to determine when required interactions with the website have not been performed and to detect changes to the website. Cycles of content/action detection by the content engine, error detection by the error engine, and action execution by the interaction engine are utilized to automatically interact with the website on behalf of the user.

The present disclosure facilitates completion of job applications on job websites. For example, the present disclosure enables a user to apply for one or multiple jobs on a single website. The present disclosure enables a user to apply for one or multiple jobs without redirection to separate job websites. The present disclosure enables job applications to be automatically completed on behalf of users. The present disclosure enables job applications to be completed on multiple/any job websites.

While the implementations of the present disclosure are described with respect to job websites and automatically interacting with job websites on behalf of users, this is merely as an example and is not meant to be limiting. The present disclosure may be applied to automate interaction with other websites on behalf of users. While the implementations of the present disclosure are described with respect to interacting with websites, the present disclosure may be applied to other electronic documents or services. An electronic document may refer to electronic media content that is intended to be used in an electronic form. An electronic document may refer to a document/file that is generated, sent, received, and/or stored by electronic, optical, or similar means. A service may refer to a web service. A service may refer to a software system that supports interoperable machine-to-machine interaction (e.g., over a network). A service may refer to a way for applications or computing devices to communicate with each other (e.g., over a network). A website, an electronic document, and/or a service may be acted upon, explored, scraped, and/or otherwise interacted with using one or more communication methods (e.g., textual communication, visual communication, audio/voice-operated communication).

The techniques described herein may be applied to facilitate automatic interaction of a computing system (e.g., the system 10 shown in FIG. 1) with an electronic document/service on behalf of a user. Components and processes described herein for automatically interacting with websites may be used in automatically interacting with electronic documents/services. For example, the techniques described herein may be applied to facilitate automatic interaction with an electronic document on behalf of a user to complete/fill-out electronic forms or to facilitate automatic interaction (e.g., textual interaction, voice interaction) with a service. References to a website may refer to one or more webpages of the website, and vice versa.

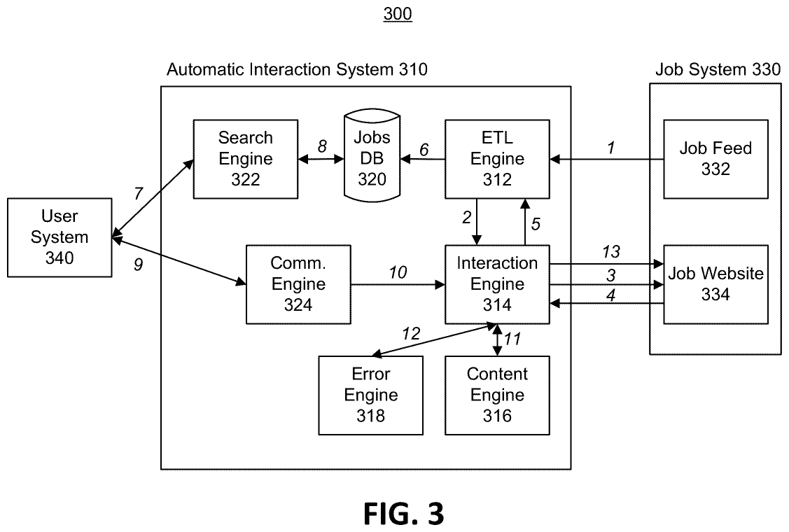

FIG. 3 illustrates an example diagram 300 of interaction between system components. An automatic interaction system 310 may communicate with a job system 330, a user system 340, and/or other systems. The automatic interaction system 310 may refer to a computing system that automatically interacts with websites on behalf of users. The automatic interaction system 310 may include or be part of the system 10 (shown in FIG. 1). The job system 330 may refer to a computing system that includes, hosts, maintains, and/or provides information relating to jobs. The job system 330 may include an applicant tracking system. The user system 340 may refer to a computing system used by a user to obtain and/or provide information for jobs. The user system 340 may include a mobile computing device and/or a desktop computing device. The user system 340 may include one or more user interface devices (e.g., keyboard, mouse, touchscreen, microphone, etc.) to operate the user system 340.

The automatic interaction system 310 may include an extract, transform, load (ETL) engine 312, an interaction engine 314, a content engine 316, an error engine 318, a jobs database 320, a search engine 322, a communication engine 324, and/or other components. The job system 330 may include a job feed 332, a job website 334, and/or other components. The systems 310, 330, 340 may include components not shown in FIG. 3. For example, the automatic interaction system 310 may include one or more databases to store information relating to users.

The job feed 332 may include information on the jobs available on the job website 334. The job feed 332 may include summary information on the jobs available on the job website 334. For example, the job feed 332 may include information on titles/identifiers of the jobs, the addresses of webpages for the jobs, and/or other information. The job feed 332 may not include all the information needed to complete job applications for the jobs. For example, the job feed 332 may not include detailed information on what information is needed from the users to complete the job applications.

The ETL engine 312 may obtain (#1) the job feed 332 from the job system 330. The ETL engine 312 may extract, transform, and/or load information within the job feed 332 for use in interacting with the job website 334. The ETL engine 312 may request (#2) the interaction engine 314 to interact with (#3) the job website to obtain (#4) additional information for the jobs, such as full description of the job, salary for the job, non-general/interview questions that need to be completed for the jobs, and/or other additional information for the job. The interaction engine 314 may interact with the job website 334 to explore/scrape the job website 334. The interaction engine 314 may interact with the job website 334 to determine/discover/learn the behavior of the job website 334 and automate interaction with the job website 334. The interaction engine 314 may interact with the job website 334 by using information for a fake/mock user to interact with the job website 334. The interaction engine 314 may interact with the job website 334 to determine/discover/learn what information and actions are required to complete job applications on the job website 334. The interaction engine 314 may communicate (#11, #12) with the content engine 316 and/or the error engine 318 in interacting (#3) with the job website 334 for exploration of the job website 334. The additional information for the jobs may be provided (#5) by the interaction engine 314 to the ETL engine 312, and the ETL engine 312 may store (#6) the information from the job feed 332 and the additional information obtained from interaction with the job website 334 in the jobs database 320. Thus, the jobs database 320 may include information for jobs from the job feed 332 and information for jobs obtained from interacting with (e.g., from scraping of) the job website 334.

Once information for the jobs are stored in the jobs database 320, the jobs may be available to the user of the user system 340. The user system 340 may request (#7) one or more searches of the available jobs to be performed by the search engine 332. For example, a search may be performed based on title, type, location, salary, and/or other information about the job. The search engine 322 may perform the search in the jobs database 320 and obtain (#8) search results for delivery to the user system 340. User selection of one or more jobs from the search result may prompt the communication engine 324 to gather (#9) information from the user. The communication engine 324 may gather information from the user through one or more of a chat session, a form, a mobile application, a desktop application, an email, and/or other communication methods. The communication engine 324 may, for initial interaction with the user, request and obtain general information about the user, such as the user's resume/CV, name, telephone number, address, and/or other general information about the user which may be required for job applications. The communication engine 324 may process the resume/CV of the user to obtain general information about the user. The communication engine 324 may, for specific jobs, request and obtain specific information about the user, such as answers to non-general/interview questions that are required for the specific jobs (e.g., information on driving license/points for driving job).

The communication engine 324 may provide (#10) the information about the user to the interaction engine 314. For example, once general information about the user and the specific information about the user are obtained, the general information and the specific information may be provided to the interaction engine 314. The interaction engine 314 may use the general information and the specific information about the user to automatically interact (#13) with the job website 334 on behalf of the user. The interaction engine 314 may mimic user behavior in interacting with the job website 334. The interaction engine 314 may communicate (#11, #12) with the content engine 316 and/or the error engine 318 in interacting (#13) with the job website 334 for completing job applications on behalf of the user.

The communication (interaction) between the interaction engine 314, the content engine 316, and the error engine 318 may enable the automatic interaction system 310 to flexibly explore/scrape the job website 334 and learn/utilize the behavior of the job website 334, and to flexibly interact with the job website 334 to complete job applications. The interaction engine 314 may be dedicated to executing (e.g., performing) actions on the job website 334, such as opening a webpage, selecting elements of the webpage, and/or filling in information on the webpage. The interaction engine 314 may be dedicated to executing actions for content (e.g., elements) of the job website 334, with the content and the actions determined by the content engine 316. The interaction engine 314 may execute the actions for the content of the job website 334 using information about a user (general information, specific information).

The interaction engine 314 may provide information for analysis by the content engine 316 and/or and the error engine 318 and obtain information from the analysis. For example, the interaction engine 314 may obtain the source code/HTML and screenshots of the job website 334 and provide the source code/HTML and screenshots to the content engine 316 for analysis. The analysis result may be returned to the interaction engine 314.

The content engine 316 may be dedicated to analyzing the content of the job website 334. The content engine 316 may analyze the content of the job website 334 using the source code/HTML and the screenshots of the job website 334. The content engine 316 may utilize a combination of machine learning techniques, computer vision, and text recognition to analyze the content of the job website 334. The content engine 316 may utilize a combination of machine learning techniques, computer vision, and text recognition to determine what actions need to be executed on the job website 334 (e.g., fill in fields, upload documents, click on next button, click on apply button, do nothing).

The content engine 316 may analyze the content of the job website 334 to determine what content exists on the job website 334 and what actions should be taken for the content of the job website 334. For example, the content engine 316 may analyze the content of the job website 334 to understand the elements (e.g., fields, buttons) on the job website 334 and interpret texts/labels associated with the elements to identify the semantics of the elements (question to be answered via interaction with the elements, label associated with the elements, meaning of the elements). The content engine 316 may determine what actions should be taken for the content of the job website 334 based on the types of the elements, the texts/labels associated with the elements, and/or the semantics of the elements. For example, one or more machine learning tools may be used to match the type, the texts/labels, and/or the semantics of the element with particular actions. The content engine 316 may analyze the content of the job website 334 to determine which elements are required (e.g., required question field) and which elements are not required (e.g., optional question field). In some implementations, only the required elements may be processed or handled.

The content engine 316 may analyze the content of the job website 334 to understand the process/flow of the job website 334. The content engine 316 may analyze the content of the job website 334 to understand how the webpage(s) of the job website 334 evolves/changes based on interaction with the elements of the job website 334 (e.g., new field(s) appears in response to clicking a button).

The error engine 318 may be dedicated to detecting errors on the job website 334. The error engine 318 may intercept errors on the job website 334. The errors detected by the error engine 318 may be used by the interaction engine 314 to recover from error or to stop interacting with the job website 334. The errors detected by the error engine 318 may be used by the interaction engine 314 and the content engine 316 during exploration/scraping to determine possible actions that can be taken by the interaction engine 314 to continue the process/flow of the job website 334. On the other hand, based on detection of an unrecoverable error, interactions with the job website 334 may be stopped.

For example, based on detection of a recoverable error associated with an uncompleted part of the job website 334, the content engine 316 may be used to analyze the part of the job website 334 corresponding to the error to determine what actions can be taken to resolve the error. For instance, if a required field of the job website 334 is left blank, an error message may be generated. The error engine 318 may detect the error message, and the content engine 316 may analyze the error and associated/nearby elements of the job website 334 to determine action(s) to fill the required field. The action to fill the required field may be sent to the interaction engine 314 for execution.

As another example, based on detection of a recoverable error associated with a network error for the job website 334, one or more of the actions for the job website 334 may be re-executed, one or more additional actions for the job website 334 may be executed, and/or the job website 334 may be reloaded. A network error may refer to an error condition that caused a network request to fail. A network error may include a server-side error, client-side error, and/or other types of error. For example, a network error may include a broken network connection and/or improper loading of the website. Based on the network error, the same action(s) for the job website 334 may be re-executed (retried) to see if the action(s) may be successfully completed. Based on the network error, other action(s) for the job website 334 may be executed to see if the other action(s) may be successfully completed (in place of the original action(s), before the original action(s) are re-executed). Based on the network error, the job website 334 may be reloaded before the action(s) are tried again.

The numbers of system interaction shown in FIG. 3 and described above are provided merely as examples and are not meant to be limiting. Other types of interactions and other orders of interactions are contemplated. For example, rather than performing a search of available jobs in the jobs database 320 using a request from the user system 340, available jobs in the jobs database 320 may be automatically searched to identify jobs for a user. For example, information about a user may be used to find jobs that match the user's expertise, experience, and/or location. Search results may be provided to the user as potential job recommendations. The user may select one or more of the jobs for application and the automatic interaction system 310 may interact with corresponding job website(s) to automatically apply for the job(s).

Use of the interaction engine 314, the content engine 316, and the error engine 318 may enable the automatic interaction system 310 to dynamically analyze the job website 334. Rather than assuming that the job website 334 is static, the automatic interaction system 310 may assume that the job website 334 is dynamic and use the interaction engine 314, the content engine 316, and the error engine 318 to (1) determine when the job website 334 has changed, determine changes to the job website 334, and change how the interaction engine 314 interacts with the job website 334 based on the change(s) to the job website 334.

The automatic interaction system 310 enables the user of the user system 340 to apply for jobs without redirection to different job websites. The automatic interaction system 310 enables the user of the user system 340 to apply for multiple jobs on a single website provided by the automatic interaction system 310. The automatic interaction system 310 enables job applications to be automatically completed on behalf of users. The automatic interaction system 310 enables job applications on multiple/any job websites to be completed.

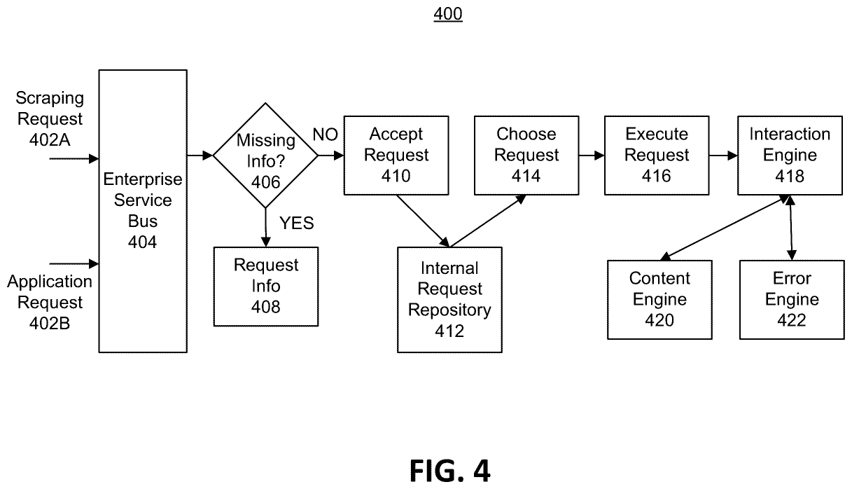

FIG. 4 illustrates an example process 400 for automatically interacting with a website. The process 400 may begin with requests 402 being received at an enterprise service bus 404. The requests 402 may include a scraping request 402A, an application request 402B (e.g., job application request), and/or other requests. The scraping request 402A for a website may prompt exploration of the website to understand the content of the website. The application request 402B may prompt interaction with the website, utilizing the understanding of the content of the website obtained from the scraping, to use the website (e.g., in completing a job application). Other types of requests (e.g., visit, action/upload) are contemplated.

Before an individual application request 402B (e.g., job application request) is accepted, information available for a user to execute the individual application request 402B may be checked to determine whether all the information required to execute (e.g., fulfill, complete) the individual application request 402B is available or whether any of the information required to execute the individual application request 402B is missing 406. For example, an application request to complete a job application for a user may be performed using general and specific information about the user stored in a database. The database may be checked to determine whether any general and/or specific information about the user needed to complete the job application is missing. Based on any required information missing from the database, the missing information may be requested from the user 408. The missing information may be requested from the user through one or more of a chat session, a form, a mobile application, a desktop application, an email, and/or other communication methods. The received information may be stored in the database for use. Based on required information for an individual application request 402B not missing from the database, the individual application request 402B may be accepted 410.

The accepted requests may be stored in an internal request repository 412. The internal request repository 412 may be used as a queue to choose requests for execution. The internal request repository 412 may function as a second queue (in addition to the queue provided by the enterprise service bus 404). The requests stored in the internal request repository 412 may be chosen for execution 414 based on priorities of the requests, available execution resources, fairness, and/or other information.

For example, an individual execution resource may be referred to as an executor. Multiple executors may run in parallel to execute different requests. In some implementations, different executors may have the same functionality. For instance, all executors may have the functionality to execute scraping requests and application requests. In some implementations, different executors may have different functionalities. For instance, some executors may have the functionality to execute scraping requests and application requests, some executors may have the functionality to execute just scraping requests, and some executors may have the functionality to execute just application requests. Other divisions of functionalities among executors are contemplated.

The queue of the internal request repository 412 may include one or more locking systems to prevent execution of requests from certain sources and/or execution of certain types of requests. For example, when multiple requests are received from the same source (e.g., multiple application requests from the same job candidate, multiple scraping requests from the same website), a limit may be placed on the number of requests that may be executed in parallel. For example, if the limit is one, and a request from the source is being executed, other requests from the same source may be locked out from being chosen for execution. The locked requests may be unlocked once the execution of the request from the source has finished.

Similarly, a limit may be placed on the number of the same type of request that may be executed in parallel. For example, if the limit is one, and an application request is being executed, other application requests of the same type may be locked out from being chosen for execution. The locked requests may be unlocked once the execution of the application request has finished. As another example, when multiple scraping requests are received for the same job title, other scraping requests for the same job title may be locked. The locked requests may be unlocked once the execution of the scraping request has finished. In some implementations, information obtained from scraping for a job may be used to increase the speed of scraping for another job with the same title. For example, previously obtained information for a job with a particular title may be used to perform one or more parts of the scraping and/or skip one or more parts of the scraping for another job with the same title.

The queue of the internal request repository 412 may include one or more round robin systems to ensure that requests from all sources and/or requests of all types are executed. For example, an executor may be assigned to one or more sources. Once the executor has performed a request from a source, the executor may not perform another request from the same source until requests from other assigned sources have been executed. For example, an executor may be assigned to sources A, B, and C. After executing a request from source A, source A may be removed from its list of requests so that it can only select a request from source B or C. Once requests from source B and C have been executed, the list may be reset to include sources A, B, and C. Different executors may be assigned to the same combination of sources or different combinations of sources.

As another example, an executor may be assigned to one or more types of requests. Once the executor has performed a request of a particular type, the executor may not perform another request of the same type until requests of other assigned types have been executed. For example, an executor may be assigned to request types A, B, and C. After executing a request of type A, type A may be removed from its list of requests so that it can only select a request of type B or C. Once requests of types B and C have been executed, the list may be reset to include types A, B, and C. Different executors may be assigned to the same combination of request types or different combinations of request types.

A request may be chosen 414 from the internal request repository 412. The chosen request may be executed 416. A request may be executed by loading instructions corresponding to the request (e.g., instructions to perform scraping; instructions to complete a job application). The instructions may include synchronous/sequential instructions, asynchronous instructions, and/or other types of instructions.

The instructions may define how an interaction engine 418 will interact with the website. The instructions may define how an interaction engine 418 will interact with the website to scrape the website or complete an application. The instructions may be generally applicable to different types of websites. If a specific website requires unique instructions, unique instructions may be written separately for the specific website. The unique instructions (for the specific website) and the general instructions (for general websites) may be loaded for execution by the interaction engine 418. The instructions may be written in a domain specific language and/or other types of language. The interaction engine 418 may communicate with the content engine 420 and the error engine 422 to execute the request/the loaded instructions. The interaction engine 418 may execute the request using a single or multiple cycles of a process.

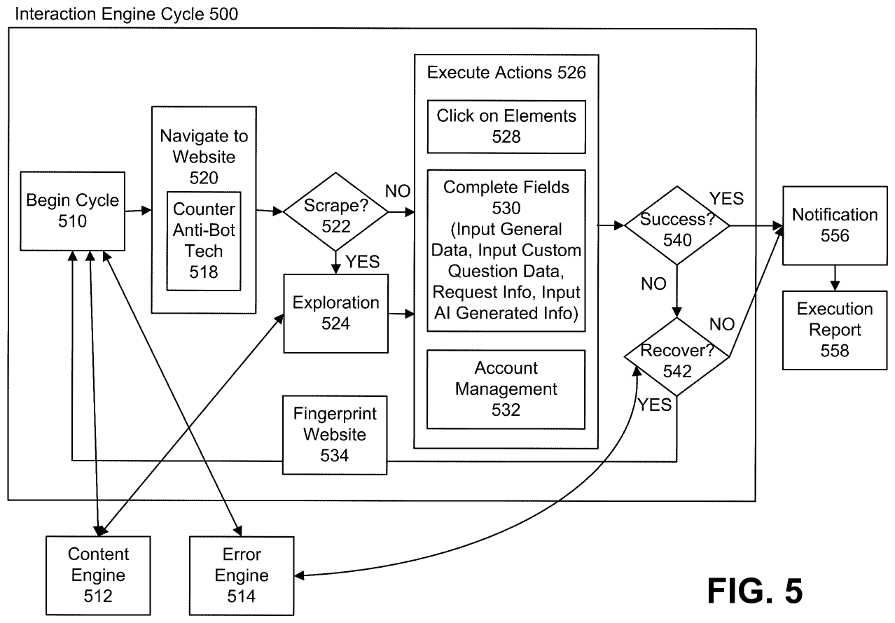

FIG. 5 illustrates an example cycle 500 of a process performed by an interaction engine for automatically interacting with a website. At the beginning 510 of the interaction engine cycle 500, the interaction engine may communicate with a content engine 512 and an error engine 514. The content engine 512 may provide detections and actions for a website (a webpage of a website), and the error engine 514 may provide error status for the website. The detections for the website may include identification of content of the website (e.g., identities of elements, positions of elements, types of elements, semantics/texts/labels of elements). Actions may include actions to be performed for the content of the website. Error status may indicate whether any errors have been detected on the website. Error status may be associated with one or more elements of the website. For example, error status may indicate whether the website has been loaded correctly and/or whether one or more required elements of the website have not been completed.

The content engine 512 and/or the error engine 514 may be used at other parts of the interaction engine cycle 500. For example, the content engine 512 may be used to analyze and provide detections and actions for a new webpage (e.g., new webpage is being explored, a new webpage has been added to the website) and/or for changes in an existing webpage (e.g., a webpage has changed based on interaction with a dynamic element; a new elements have been added to the webpage).

The interaction engine cycle 500 may continue with navigation to the website, such as to a particular webpage of the website. One or more browsers may be utilized to navigate to the website and/or to interact with the website 520. In navigating/interacting with the website, inbound and outbound connections on the website may be monitored to ensure that one or more actions have been completed (e.g., tasks have been successfully performed) before other/additional actions are taken. For example, ongoing outbound HTTP requests on a browser instance may be tracked so that no additional requests are sent to the website until the tracked/ongoing requests have been completed (e.g., succeeded, failed). Such monitoring may ensure that input controls are ready for action. For example, when a user's resume/CV is being uploaded, the inbound and outbound connections on the website may be monitored to ensure that the user's resume/CV has been successfully uploaded before taking additional actions.

In navigating/interacting with the website, one or more counter anti-bot technologies 518 may be deployed. For example, a proxy (e.g., residential proxy) may be used to make network access/requests look like network access/requests coming from a non-data center location (e.g., from a user located in the same country as the location of a job on the website). DDoD protection bypass may be used to prevent/reduce the likelihood of network access/requests being detected as a distributed denial-of-service attack. Information relating to the browser that accesses the website may be modified (e.g., browser type, browser version, operating system running the browser, screen resolution, browser parameters) so that requests appear to be made by many different users. Browser information may be modified in case the type/version of the browser being used is being blocked. Similarly, information relating to the user of the browser may be modified (e.g., via use of multiple/random user agents for a single user to generate multiple digital fingerprints for the single user) so that the same user does not appear to be making numerous requests on the website. In addition to its use in circumventing anti-bot technology, user agents/fingerprints may be used to track users and their activities. Delays may be inserted inside and/or between execution of actions to simulate user behavior. For example, delays may be inserted between entries of text (e.g., letters, numbers) in a field to simulate a person typing the text in the field. Delays may be inserted when switching between fields to simulate a person navigating the website. The length of delays may be static (set) or dynamic (changing). Thus, the interaction with the website may utilize intentional delays to simulate a real person interacting with the website. Additionally, the monitoring of inbound and outbound connections on the website may work as part of the counter anti-bot technologies 518. Delaying action(s) until completion of other action(s) may operate as a pacing measure for requests, preventing too many requests on the website within a short duration of time and mitigating the possibility that the website will view the requests as coming from a bot.

The request being executed may be checked to determine whether or not it is a scraping request 522. If the request is a scraping request, the interaction engine cycle 500 may continue with exploration 524. The exploration 524 may be performed to obtain additional information for jobs (e.g., full description, salary, non-general/interview questions). The exploration 524 may be performed to determine/discover/learn the behavior of the website and automate interaction with the website. If the request is not a scraping request, the interaction engine cycle 500 may continue with executing actions for the website 526. The exploration 524 may be skipped for non-scraping requests.

During the exploration 524, elements of the website may be interacted upon to determine if the content of the website changes. For example, elements of the website may include different possible options for selection/use (e.g., clicking a button, clicking among a set of buttons, selection/insertion of particular value in a field). Individual selectable options may be tried to determine if the content of the website changes. Whether the content of the website changes or not may be determined based on comparison of fingerprints. A fingerprint for the website may be generated before any interaction with the website is performed. After interacting with an element of the website, another fingerprint may be generated and compared with the previously generated fingerprint. The fingerprints may be the same if the interaction with the element of the website did not change the content of the website. The fingerprints may be different if the interaction with the element of the website changed the content of the website (e.g., clicking on a button added new elements, a dynamic field being displayed based on the value of another field). Every combination of selectable options for the element may be tried to determine when the content of the website changes. The exploration 524 may work along a path of selectable options for the elements until there are no new options, and then return to explore other paths of selectable options for the elements. The exploration 524 may build a hierarchy of selectable options for the elements of the website.

The content engine 512 may be called during the exploration 524 to analyze the website. When a change in the content of the website is detected (a new webpage, a change in an existing webpage), the content engine 512 may be called to analyze the changed part of the website. After the content of the website has been detected via the content engine 512, subsequent analysis of the website by the content engine 512 may be limited to the changed part of the website to limit time, power, and processing resources needed to analyze the website. Textual (source code, HTML), visual (screenshot), and/or audio (e.g., sound) analyses of the website may be used to understand the changed content of the website, and to determine actions for the changed content of the website. On the other hand, interaction with selectable options for the elements of the website (to explore paths of selectable options/build a hierarchy of selectable options) may be performed by the interaction engine without use of the content engine 512. Use of the content engine 512, which utilizes a combination of machine learning techniques, computer vision, and text recognition, may be computationally expensive. Limiting the use of the content engine 512 for new webpages and changes to existing webpages may reduce time, power, and processing resources needed to interact with the website.

The interaction engine cycle 500 may proceed with executing actions 526 for the content of the website. The actions may be executed based on detections and actions provided by the content engine 512. Detections and actions provided by the content engine 512 may be converted into instructions for execution to execute the actions. Different instructions may exist for different actions, and the detections may be used to control how the corresponding instructions are used to execute the actions. The instructions may be written in a general way to enable the actions to be executed based on the detections. Rather than having granular, step-by-step instructions that are tailored to specific websites, which include step-by-step instructions of performing actions for specific websites, a list of general instructions may be used to perform the actions. The instructions may include instructions to perform monolithic actions and/or instructions to perform fine-grained actions.

For example, an action to be executed may include clicking on elements 528 of the website. Rather than having granular, step-by-step instructions to control the cursor (e.g., up, down, left, right, amount of movement) and position it over an element, instructions may refer to an identifier for where to perform the click (e.g., an element ID as click_next). An action to be executed may include completing fields 530. Rather than having granular, step-by-step instructions to specify where to find the field, activate the field, and enter specific information into the field, instructions to insert information into the field may also use identifiers for the information to be inserted (linked to the corresponding user information coming from the database) along with identifiers of the corresponding input controls into which the information should be inserted. The fields may be completed by inserting general information (input general data, such as name or address), inserting specific information (input interview question data, such as answers to non-general/interview questions), and/or other information. For scraping, fake/mock user information may be used.

If a new question is found (e.g., based on changes in the website between the exploration 524 and execute actions 526), the content engine 512 may be used to analyze the new question and determine an appropriate answer for the question. If the answer to the new question is not in the user information stored in the database, then the missing information may be requested from the user, obtained from the user, stored in the database for use, and used to answer the new question.

If the form of the user information stored in the database does not match the form of the information to be filled, one or more machine learning/AI models may be used to change the form of the information. For instance, a large language model may be used to convey the same underlying information while using different words (e.g., university degree vs bachelor's degree). Machine learning/AI model(s) may be used to generate free text answers to questions. The user information (e.g., text from the user's resume/CV) may be used as inputs to the machine learning/AI model(s). Execution of other types of actions are contemplated.

Different cycles of execution may be used for individual actions (e.g., separate cycles of executions for click on elements 528 and complete fields 530). When all actions provided by the content engine 512 have been executed, the next action(s) may be requested from the content engine 512.

Account management 532 may be used when user accounts are required to interact with the website. For example, the account management 532 may store and use usernames and passwords for websites. The account management 532 may log in and out of websites as needed to interact with the website. The account management 532 may create a user account on a website for a user, such as by using the user's email address as the username and creating a password for the user account. The username and the password may be provided to the user. The account management 532 manages limits on login attempts on websites (e.g., limit how many times login may be attempted within a certain interval; set minimum time duration between login attempts) to prevent the user account from being locked.

Whether the interaction with the website was successfully performed may be determined 540. Whether the actions were successfully executed on the website may be determined 540. Success of the interaction/actions may include completion of required interaction with the website (e.g., completing job application, completing scraping). Determining success of the interaction/actions may include checking the error status provided by the error engine 514. If successful, no errors may be detected by the error engine 514. If not, one or more errors may be detected by the error engine 514.

Error(s) may be detected 542, Whether an error is a recoverable error or an unrecoverable error may be determined. If a recoverable error is detected, the interaction engine cycle 500 may begin again to fix the recoverable error. In the new cycle, the error status provided by the error engine 514 along with detection and actions provided by the content engine 512 may be used to fix the recoverable error. For example, if the recoverable error includes incompletion of one or more required parts of the website (e.g., missing information in a field, missing button interaction), the corresponding part(s) of the website may be analyzed by the content engine 512 and appropriate actions may be executed by the interaction engine to complete the missing parts of the website. If the recoverable error includes a network error, one or more of the original actions for the website may be re-executed, one or more additional actions for the website may be executed, and/or the website may be reloaded. For the new cycle, a fingerprint 534 of the website may be generated. The fingerprint 534 may be generated based on the actions that have been performed for the website. The fingerprint 534 may indicate that the website has already been processed (e.g., scraped, application started). The fingerprint 534 may be used to determine the status of the application.

If an unrecoverable error is detected, the interaction with the website may stop. Failure may be reported in a notification 556. The notification may be provided to the originator of the request (e.g., scraping request, application request), the operators of the automatic interaction system 310, monitoring systems, and/or other persons/entities. If the interaction with the website was successful, the success may be reported in the notification 556.

One or more execution reports may be generated for the website 558. An execution report may include information on interaction with the website. An execution report may provide information on how the interaction with the website was performed and/or information on the results of interaction with the website. Information on interaction with the website may include information on how the content engine and/or the interaction engine interacted with the website, information on results of the interaction with the website, information on errors detected by the error engine, and/or other information. For example, an execution report may include information on content of the website, information on additional information for jobs obtained through exploration of the website, detections and actions for websites identified by the content engine, errors detected by the error engine, instructions executed by the interaction engine, and/or other information relating to interaction with the website. An execution report may provide infographics for individual steps of the scraping process and/or the application process. An execution report may include screenshots of the website. The screenshots of the website may be marked with shapes and/or text to convey the detections and actions identified by the content engine, errors detected by the error engine, instructions executed by the interaction engine, and/or other information relating to interaction with the website. An execution report may provide visualization of how various elements of the website are being interpreted and acted upon during interaction. An execution report may enable an operator/engineer to step through interaction with the website to confirm/verify the interaction or identify errors/source of errors in the interaction.

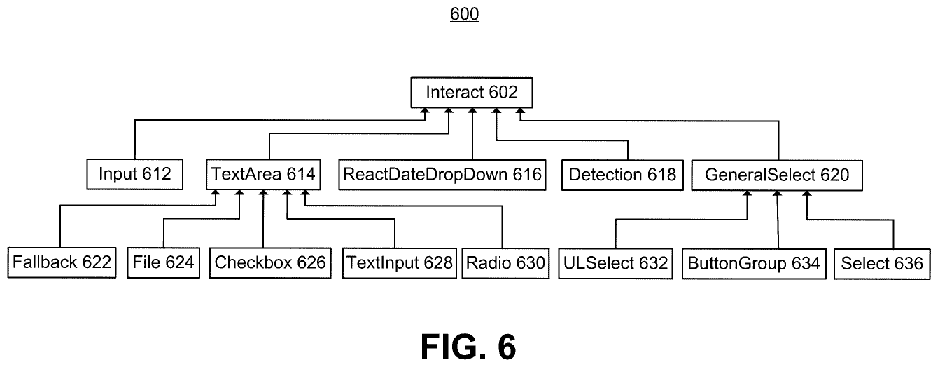

FIG. 6 illustrates an example hierarchy 600 of components for interacting with a website. An interaction engine may use interaction components shown in FIG. 6 to interact with a website. Interact component 602 may be split into input component 612, textarea component 614, reactdatedropdown component 616, detection component 618, and general select component 620. Textarea component 614 may be split into fallback component 622, file component 624, checkbox component 626, textinput component 628, and radio component 630. Generalselect component 620 may be split into ulselect component 632, buttongroup component 634, and select component 636.

Different interaction components may include different instructions to interact with different content of the website. Different interaction components may include different instructions to interact with different types of elements of the website. Different interaction components may include different instructions to perform different actions for the website.

The interact component 602 may be used as a base component to define all the common functionality among all the other interaction components. The interact component 602 may interact with the interaction engine and allows it to operate with a webpage in a generic manner.

The input component 612 may be used as a base component for all webpage input elements (e.g., radio, checkbox, text input, etc.). The input component 602 may include instructions to interact with all input components. The input component 612 may include instructions that, when executed, insert and/or read values from an input tag.

The textarea component 614 may be used when there is a textarea in a webpage. The textarea component 614 may include instructions to interact with textareas. The textarea component 614 may include instructions that, when executed, insert and/or read the value from a textarea.

The reactdatedropdown component 616 may be used to work with a webpage that contains date fields created with the React library. The reactdatedropdown component 616 may include instructions for identifying date fields with React and/or setting their value. The reactdatedropdown component 616 may include instructions that, when executed, identify date fields with React and/or set values of data fields with React.

The detection component 618 may be used when other types of interaction components are not compatible with the content of the website. The detection component 618 may include instructions to interact with any content of the website. The detection component 618 may include instructions that, when executed, utilize the detection engine to detect where within the website the interaction is required and insert the required information into the detected position.

The general select component 620 may be used as a base component for all components that work with drop-down menus on the page. The general select component 620 may include instructions for identifying drop-down elements in an HTML page and generic methods for working with them. The general select component 620 may include instructions that, when executed, identify drop-down elements in an HTML page and work with them using generic methods. The general select component 620 may include instructions to retrieve the full list of options available for a drop-down item. The general select component 620 may include instructions that, when executed, retrieve the full list of options available for a drop-down item.

The fallback component 622 may be used to interact with any elements of a website. The fallback component 622 may include instructions to interact with any elements of a website. The fallback component 622 may include instructions that, when executed, simulate the iteration of a user clicking in the center of an element and simulate the keyboard to send a sequence of characters to the element. The fallback component 622 may include instructions that, when executed, simulate latency during value insertion.

The file component 624 may be used to upload file(s) to a website. The file component 622 may include instructions to upload one or more files to a website. The file component 622 may include instructions that, when executed, cause a file to be uploaded to a website.

The checkbox component 626 may be used to mark/unmark checkboxes of the website. The checkbox component 626 may include instructions to interact with checkboxes of the website. The checkbox component 626 may include instructions that, when executed, mark or unmark checkboxes of the website.

The textinput component 628 may be used to insert text (e.g., letters numbers) into text fields of the website. The textinput component 628 may include instructions to interact with text fields of the website. The textinput component 628 may include instructions that, when executed, insert text into text input fields of the website.

The radio component 630 may be used to select/unselect radio buttons of the website. The radio component 630 may include instructions to interact with radio buttons of the website. The radio component may include instructions that, when executed, select or unselect radio buttons of the website.

The ulselect component 632 may be used to select a value from a webpage drop-downs menu created using lists of points (ul/li tags). The ulselect component 632 may include instructions to identify lists of points used as drop-downs. The ulselect component 632 may include instructions that, when executed, allow a value to be selected from such lists.

The buttongroup component 634 may be used to select a button in a list of buttons used as a select list. The button group component 634 may include instructions to select a button from a list of available buttons. The buttongroup component 634 may include instructions that, when executed, select a button from a list of available buttons.

The select component 636 may be used to interact with select elements of an HTML page. The select component 636 may include instructions to extract all the options of a select element. The select component 636 may include instructions that, when executed, extract options of a select element. The select component 636 may include instructions to select a value from a list of values. The select component 636 may include instructions that, when executed, select a value from a list of values. Other interaction components to interact with websites and other hierarchy of interaction components are contemplated.

For individual actions to be performed for the content of the website, one or more interaction components may be selected for execution. For example, for individual elements of the website, one or more interaction components may be selected, and the instructions of the selected interaction component(s) may be executed to interact with the individual elements of the website. The instructions may be modified using the detections for the website. For example, a website may include a text field labeled “First Name.” The action for this field may include “fill-in field” and the detection for this field may include “First Name.” The textinput component 628 may be selected to interact with this field, and the instructions for the textinput component 628 may be executed with reference to the first name of the user stored in the database (e.g., “data.firstname”). Thus, the action and the detection for the element may be used to automatically select the interaction component to perform the identified action and select the user information stored in the database for use in performing the action. The selected interaction component may be executed using the selected user information stored in the database to automatically interact with the element.

For individual actions and/or elements, a check may be made against the interaction components to determine which interaction component will be used. For example, the interaction components may be ordered in a list, and the interaction components in the list may be queried one by one to see if the interaction components support the action (e.g., able to perform the action) and/or the element (e.g., able to interact with the element). The interaction component that is queried may reply with information on whether it is able to support the action and/or the elements (e.g., reply true or false). If the interaction component replies that it is able to support the action and/or the element, the action and/or the element may be assigned/delegated to that interaction component. Values from the detection may be passed to the interaction component for use in performing the action for the element. If the interaction component replies that it is not able to support the action and/or the element, the next interaction component in the list may be queried. If none of the interaction components (besides the detection component 618) support the action and/or the element, the action and/or the element may be assigned/delegated to the detection component 618.

Such selection of interaction components provides flexibility in use and extensibility of the interaction components. For example, a particular type of action or element may not be supported by any of the existing interaction components. In such a case, the action/element may be assigned/delegated to the detection component 618. For example, the detection component 618 may be used when none of the other interaction components support the particular type of action or element. When an interaction component that is capable of supporting the particular type of action or element is added, such interaction component may be implemented for use by adding the new interaction component to the list of interaction components. Next time the list is used to select the interaction component, this newly added interaction component, rather than the detection component 618, may be used.

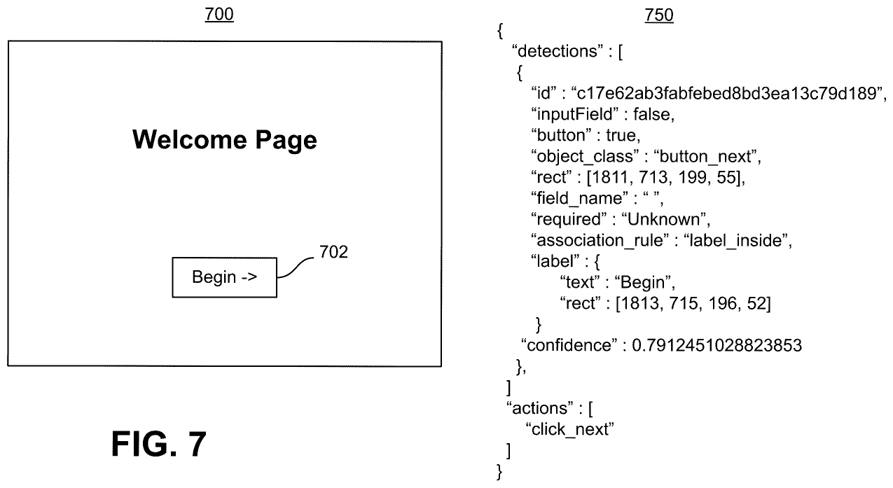

FIG. 7 illustrates example detections and actions for a webpage. A webpage 700 may include a button 702 and/or other content. The content engine may analyze the source code/HTML and one or more screenshots of the webpage 700 to understand the content of the webpage 700 and to determine actions for the content of the webpage 700. For example, in FIG. 7, the content engine may detect the button 702 within the webpage 700. The content engine may generate and provide detections and actions 750 for the button 702. The detections may include information on identity, type, position, and/or semantic of the button 702. The detections may include the identifier for the button 702, determination that the button 702 is not an input field, determination that the button 702 is a button, classification of the button 702 as “button_next” (next button), the position of the button 702 within the webpage 700, association of the button 702 with a label inside the button, the label that was detected within the button 702, the position of the label within the webpage 700, and the confidence of the detections. The actions may include actions to be performed for the button 702. The actions may include clicking on next (next button).

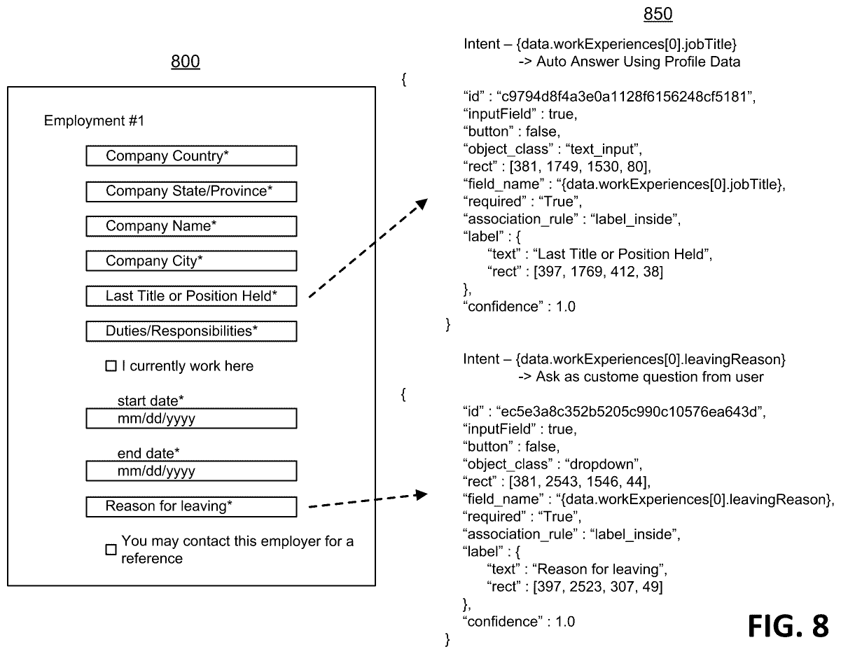

FIG. 8 illustrates example detections for a webpage. A webpage 800 may include fields, checkboxes, and/or other elements. The content engine may analyze the source code/HTML and one or more screenshots of the webpage 800 to understand the content of the webpage 800 and to determine actions for the content of the webpage 800. For example, in FIG. 8, the content engine may detect the fields, checkboxes, and/or other elements of the webpage 800. The content engine may generate and provide detections and actions for the fields, checkboxes, and/or other elements of the webpage 800. For example, in FIG. 8, detections 850 are shown for two fields of the webpage 800. The detections 850 may include the intent of the questions for the fields (whether the field requires general information (e.g., title of prior job) or specific information (e.g., why the user left the prior job) about a user), the identifiers for the fields, determination that the fields are input fields, determination that the fields are not buttons, classification of the fields as “text_input” or “dropdown”, the positions of the fields within the webpage 800, association of the fields with labels inside the fields, the label that was detected within the fields and the positions of the labels within the webpage 800, and the confidence of the detections. The detections 850 may include field names for the fields, with the field names including conversion of the semantics/texts/labels for the fields converted into references of where the corresponding information is stored in the database of user information.

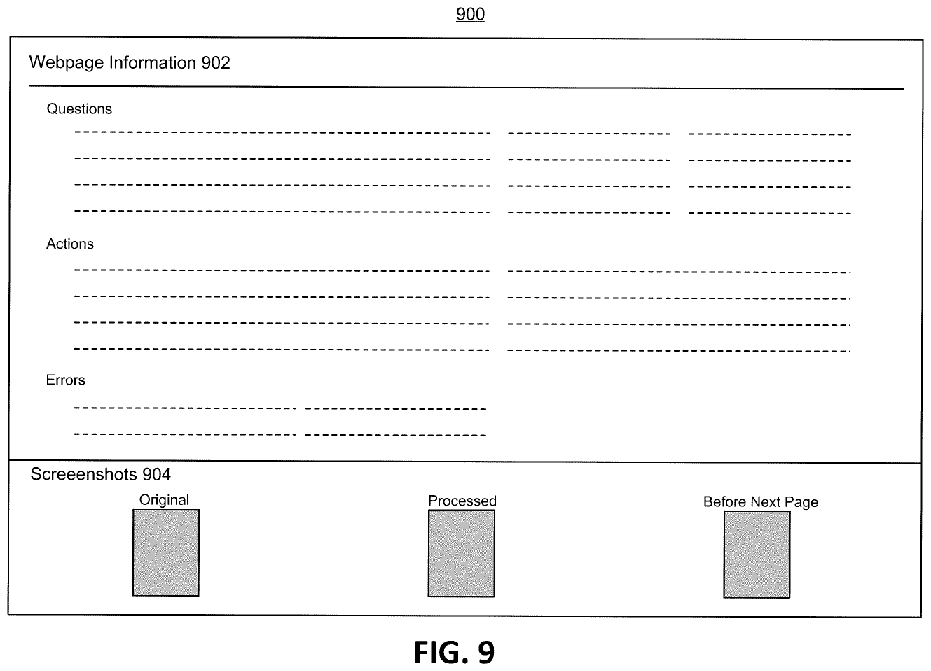

FIG. 9 illustrates an example execution report 900 for a webpage. The execution report 900 may provide information on how the interaction with the website was performed and/or information on the results of interaction with the website. For example, the execution report 900 may include webpage information 902. The webpage information 902 may include information that identifies a webpage (e.g., webpage identifier, webpage source, webpage type, URL, etc.) and information on interaction with the webpage. For instance, the webpage information 902 may include a list of questions found on the webpage and the types of answers to be provided for the questions (e.g., open text, a choice between options, selectable options). The webpage information 902 may include a list of actions for the content of the webpage. The webpage information 902 may include actions to be performed for the content of the webpage. The webpage information 902 may include how the actions were performed for the content of the webpage (e.g., interaction components that were used, detections used to perform the action). The webpage information 902 may include information on results of the actions performed for the content of the webpage. The webpage information 902 may include information on errors detected within the webpage. The webpage information 902 may include other information on the interaction with the webpage.

The execution report 900 may include screenshots 904 of the webpage. The execution report 900 may include screenshots 904 of the webpage with visualization of interaction with the webpage, such as visualization of detections and actions identified by the content engine. The execution report 900 may include screenshots 904 of the webpage at various stages of interaction with the webpage (e.g., screenshots of the original webpage, screenshots of the webpage with detections and actions identified by the content engine, etc.).

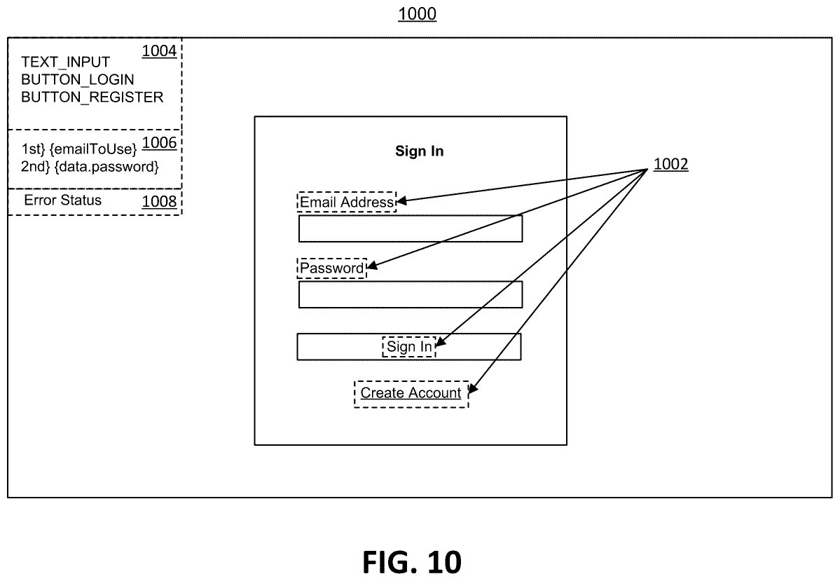

FIG. 10 illustrates an example visualization 1000 of interaction with a webpage. The visualization 1000 may include a screenshot of the webpage, along with marking to indicate how the webpage was interpreted using the content engine. For example, the visualization 1000 may include markings 1002 around text/labels within/near three fields and a link (to create an account). The text/labels may be associated with the fields and the link. The visualization 1000 may include information on types 1004 of elements detected within the webpage, the semantics/text/labels 1006 corresponding to the elements detected within the webpage, and the error status 1008 of the webpage.

Referring back to FIG. 1, the processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate interaction with web interfaces on behalf of users. The machine-readable instructions 100 may include one or more computer program components. The machine-readable instructions 100 may include a scrape component 102, a user component 104, a content component 106, an action component 108, an error component 110, an execution component 112, and/or other computer program components.

The scrape component 102 may be configured to scrape a website. A website may refer to a set, a collection, or a grouping of webpages. A website may include one or more webpages. Webpages of a website may share a single domain name. A webpage may refer to a hypertext document. A webpage may include a text file written in markup language that describes the content of the webpage and includes references to one or more resources. A webpage may include a structured document that includes text with links, with the links pointing to one or more resources. References to a website may refer to one or more webpages of the website, and vice versa.

A website/webpage may be hosted by a server. A webpage may be identified by a uniform resource locator (URL). A webpage may be delivered by the server to a computing device (e.g., a mobile computing device, a desktop computing device) and displayed in a browser of the computing device. A webpage may require authentication of users before the users can interact with the content (e.g., elements) of the webpage. A webpage may provide a general experience for all users. A webpage may provide a customized experience for one or more users. For example, authentication of users may enable a webpage to be customized for particular users.

A browser may refer to an application for accessing websites. A browser may refer to a mobile browser, a desktop browser, and/or other types of browser. A browser may refer to a general-purpose browser that is able to interact with webpages in general. A browser may refer to a specific-purpose browser that is designed to interact with specific webpages (e.g., browser applications for mobile devices designed to access specific URLs). A browser may enable a user to navigate to different parts of a webpage or between different webpages. A browser may create a history of accessed webpages and enable a user to go backwards and/or forward between previously accessed webpages. A browser may include one or more graphical user interfaces for displaying and navigating websites. A browser may cause sound to be played by the computing device. A browser may cause the computing device to vibrate and/or move.

A browser may obtain a webpage by requesting the server to provide the webpage corresponding to the URL. When a request is made at the URL, the webpage (e.g., HTML file for the webpage) may be provided by the server and downloaded by the browser. The browser may utilize the text, markup, content, references, and/or other information contained in the webpage to render an expression of the webpage. The browser may transform the content of the webpage into an interactive visual and/or audio representation on the computing device running the browser. The content of the webpage may include visual elements, audio elements, haptic elements, static elements, dynamic elements, interactive elements, non-interactive elements, and/or other elements. Automatically interacting with a webpage on behalf of a user may include automatically interacting with one or more elements of the webpage on behalf of the user.

In some implementations, a website may include one or more job application webpages. A user may need to navigate through multiple job application webpages to complete a job application. A job application webpage may refer to a webpage with content/elements designed to facilitate a job application process. A job application webpage may refer to a webpage that a user may interact with to complete a job application. A job application webpage may include one or more elements that a user may interact with to complete a job application. For example, a job application webpage may include fields (e.g., text fields, drop-down fields), radio buttons, checkboxes, upload buttons, action buttons (e.g., navigation buttons, apply buttons), one or more input controls, and/or other elements for interaction by a user. Automatically interacting with a website on behalf of a user may include automatically interacting with the elements of the job application webpage(s) on behalf of the user. For example, automatically interacting with a website on behalf of a user may include automatically completing fields using user information, automatically selecting/unselecting ratio buttons, automatically marking/unmarking checkboxes, automatically uploading files (e.g., resume/CV files, image files, sound files), automatically navigating through webpages, automatically completing interaction with the webpages (e.g., applying for a job), and/or otherwise automatically interacting with the website on behalf of a user.

Scraping a website may refer to a process of extracting information from the website. Scraping a website may refer to a process of extracting information from one or more webpages of the website. Scraping a website may refer to a process of extracting information from some or all webpages of the website. Scraping a website may include exploring the content of the website to understand the content of the website. The content of the website may be explored via interaction (e.g., pressing buttons, selecting options, voice-interaction) with elements of the website. A website may be scraped to determine/discover/learn the behavior of the website, and the behavior of the website may be used to automate interaction with the website. A website may be scraped to understand the process/flow of the website. A website may be scraped to understand how the website evolves/changes based on interaction with the website.

Scraping may be performed on a website basis, a webpage basis, a subject (e.g., job) basis, and/or other basis. For example, to perform scraping for a job, one or more job application webpages of a website that are required to apply for the job may be scraped.

Scraping a website may include textual, visual, and/or audio analyses of the website. The content of the website may be analyzed using both the source code/HTML of the website and screenshots of the website. For example, a combination of machine learning techniques, computer vision, and text recognition may be used to analyze the content of the website. A combination of machine learning techniques, computer vision, and text recognition may be used to determine what actions should be performed on the content of the website. For example, a website may be scraped to identify the elements of the website, identify texts/labels associated with the elements of the websites, and use the texts/labels associated with the elements to determine what actions should be performed for the elements. Audio analysis of the website may include analysis of audio content provided by the website. For example, audio analysis of the website may include recognition of sounds, words, sentences, and/or other audio content provided by the website to determine what actions should be performed for the elements of the website.

The scrape component 102 may be configured to interact with the content of a website to determine possible interactions with the content of the website. During scraping, elements of the website may be interacted upon to determine if the content of the website changes. For example, elements of the website may include different possible options for selection/use (e.g., clicking a button, clicking among a set of buttons, selection/insertion of particular value in a field). Individual selectable options may be tried to determine if the content of the website changes. Every combination of selectable options for the element may be tried to determine when the content of the website changes. Different paths of selectable options may be tried for the website to build a hierarchy of selectable options for the elements of the website. Fake/mock user information may be used to scrape the website. For example, fields of a job application webpage may be completed using fake/mock user information to enable the scraping process to proceed through the entirety of the job application webpage. When a change in the content of the website is detected (a new webpage, a change in an existing webpage), textual and visual analyses may be performed for the changed content of the website to understand the changed content of the website and to determine actions for the changed content of the website.

The user component 104 may be configured to obtain user information and/or other information. Obtaining user information may include one or more of accessing, acquiring, analyzing, determining, examining, generating, identifying, loading, locating, opening, receiving, retrieving, reviewing, selecting, storing, and/or otherwise obtaining the user information. The user component 104 may obtain user information from one or more locations. For example, the user component 104 may obtain user information from a storage location, such as the electronic storage 13, electronic storage of a device accessible via a network, and/or other locations. The user component 104 may obtain user information from one or more databases. The user component 104 may obtain user information from one or more engines dedicated to a particular function, such as the communication engine 324 (shown in FIG. 3).

The user information for a user may include a collection of information associated with the user. The user information for a user may include information associated with the user for use in interacting with the website on behalf of the user. The user information for a user may include general information about the user, specific information about the user, and/or other information about the user. General information about the user may refer to information that is generally required for use in general interaction with a website. For example, general information about the user may refer to information, such as the user's resume/CV, name, telephone number, address, and/or other general information about the user, which may be required for job applications in general. Specific information about the user may refer to information that is required for use in specification interaction with a website. For example, specific information about the user may refer to information, such as the user answers to non-general/interview questions, which may be required for specific applications. Other types of user information are contemplated.

In some implementations, the user information for a user may be obtained directly from the user. For example, a user may be prompted to provide information, through one or more of a chat session, a form, a mobile application, a desktop application, an email, and/or other communication methods, to be contained within the user information for the user. For instance, when an account for the user is created and/or the user applies for a job for the first time, the user may be prompted to provide general information about the user. When the user indicates the jobs for which applications are to be completed, the user may be prompted to provide specific information about the user for the jobs.

In some implementations, the user information for a user may be obtained indirectly from the user. For example, information provided by the user may be analyzed to determine general information about the user, specific information about the user, and/or other information about the user. For example, the user's resume/CV may be analyzed to general information and/or specific information about the user.

In some implementations, the user component 104 may be configured to request missing information from a user for use in interacting with the website on behalf of the user. Missing information may refer to information that is required for interacting with the website but is not contained within the user information for the user. The user component 104 may request missing information from a user before starting to interact with the website or while the interaction with the website is ongoing. For example, before starting to interact with a job application webpage on behalf of a user, the user component 104 may check the user information for the user to determine whether or not it contains all the information required to interact with the job application webpage. If information is missing, the user may be prompted to provide the missing information. The information provided by the user may be stored for use in the user information for the user. As another example, during interaction with a job application webpage on behalf of a user, a new question may be detected on the job application webpage. The user information for the user may not include the information needed to answer the new question, and the user may be prompted to provide the missing information. The information provided by the user may be stored for use in the user information for the user.

The content component 106 may be configured to obtain content information for the website and/or other information. Obtaining content information may include one or more of accessing, acquiring, analyzing, determining, examining, generating, identifying, loading, locating, opening, receiving, retrieving, reviewing, selecting, storing, and/or otherwise obtaining the content information. The content component 106 may obtain content information from one or more locations. For example, the content component 106 may obtain content information from a storage location, such as the electronic storage 13, electronic storage of a device accessible via a network, and/or other locations. The content component 106 may obtain content information from one or more engines dedicated to a particular function, such as the content engine 316, 420, 512 (shown in FIGS. 3, 4, and 5).

The content information for the website may define the content of the website. The content of the website may refer to things contained within/provided by the website. The content of the website may refer to interactive and/or non-interactive components of the website. The content of the website may include visual components, such as text, shapes, and/or images. The content of the website may include audio components, such as sounds. The content of the website may include interactive components, such as elements. The content of the website may include elements of the website to be interacted with on behalf of a user. The content of the website may include required elements of the website. The content of the website may include elements of the website that need to be acted upon on behalf of the user. The elements of the website may be interacted with by clicking (e.g., pressing, selecting, marking) the elements. The elements of the website may be interacted with by inserting information into the elements. For example, the elements of the website may include one or more text fields, one or more drop-down fields, one or more radio buttons, one or more checkboxes, one or more upload buttons, one or more action buttons, one or more input controls, and/or other elements. A text field may refer to an open-ended field in which text (e.g., letters, numbers) may be inserted. A drop-down field may refer to a closed-ended field in which a selection may be made from a list of options (e.g., list of choices). A radio button may refer to a graphical element that represents one of a set of options. One or multiple options may be selected via one or multiple radio buttons. A checkbox may refer to a graphical element (e.g., a box, a circle) that enables a binary choice to be made (e.g., mark to answer yes, not mark to answer no). An upload button may refer to a graphical element that facilitates upload of information to the website (e.g., initiates an upload process in which one or more files are identified and transmitted to the website). An action button may refer to a graphical element that enables control of how the website is navigated and/or operated (e.g., navigation buttons to move forward or backward, such as to the next webpage or to the prior webpage, in an application process; apply button to complete the application process). An input control may refer to an interactive element. An input control may allow for entry of information. Other types of elements are contemplated.

The content information may define the content of the website by characterizing, describing, identifying, quantifying, reflecting, and/or otherwise defining the content of the website. The content information may define the content of the website by including information that defines one or more content, qualities, attributes, features, and/or other aspects of the content of the website. The content information may define the content of the website by including information that identifies types and/or locations of elements of the website. The content information may define the content of the website by including information from which the types and/or locations of elements of the website may be determined. For example, the content information may include information on identities of elements, positions of elements, types of elements, texts/labels of the elements, semantics of the elements, and/or other information relating to the elements. The content information may include information on detections of the elements of the website, such as information on types of detections as shown in FIGS. 7 and 8. Other types of content information are contemplated.

The action component 108 may be configured to obtain action information for the website and/or other information. Obtaining action information may include one or more of accessing, acquiring, analyzing, determining, examining, generating, identifying, loading, locating, opening, receiving, retrieving, reviewing, selecting, storing, and/or otherwise obtaining the action information. The action component 108 may obtain action information from one or more locations. For example, the action component 108 may obtain action information from a storage location, such as the electronic storage 13, electronic storage of a device accessible via a network, and/or other locations. The action component 108 may obtain action information from one or more engines dedicated to a particular function, such as the content engine 316, 420, 512 (shown in FIGS. 3, 4, and 5).

The action information for the website may define actions for the content of the website. The actions for the content of the website may refer to ways in which the content of the website is to be interacted with on behalf of a user. The actions for the content of the website may define how the elements of the website are to be interacted with on behalf of the user. Example actions for the elements of the website may include clicking the elements (e.g., use of pressing, selecting, and/or marking for drop-down fields, radio buttons, checkboxes, upload buttons, and/or action buttons), filling in elements (e.g., inserting information into text fields), and/or other actions. Other types of actions, such as inputting of audio and/or image/video, are contemplated. The actions for the content of the website may be determined based on analysis of the content of the website. The actions for the elements of the website may be determined based on the types of elements, the texts/labels of the elements, semantics of the elements, and/or other information relating to the elements of the website. The actions for the elements of the website may be determined using one or more machine learning tools. For example, a machine learning model may be trained using types, semantics, texts, and/or labels of the elements as input and actions as output. The trained machine learning model may be used to output actions for elements based on input of types, semantics, texts, and/or labels of the elements into the machine learning model. Use of other machine learning models and/or other tools to determine actions for elements of the website is contemplated.

The action information may define the actions for the content of the website by characterizing, describing, identifying, quantifying, reflecting, and/or otherwise defining the actions for the content of the website. The action information may define the actions for the content of the website by including information that defines one or more content, qualities, attributes, features, and/or other aspects of the actions for the content of the website. The action information may define the actions for the content of the website by including information that identifies types of actions to be performed for the content of the website. The action information may define the actions for the content of the website by including information from which the types of actions to be performed for the content of the website may be determined. For example, the action information may include information on what actions should be performed on the website, such as how the elements of the website are to be interacted with on behalf of the user, and/or other information relating to the actions for the content of the website. The action information may include information on actions for the elements of the website, such as information on types of actions as shown in FIG. 7. Other types of action information are contemplated.

The error component 110 may be configured to obtain error information for the website and/or other information. Obtaining error information may include one or more of accessing, acquiring, analyzing, determining, examining, generating, identifying, loading, locating, opening, receiving, retrieving, reviewing, selecting, storing, and/or otherwise obtaining the error information. The error component 110 may obtain error information from one or more locations. For example, the error component 110 may obtain error information from a storage location, such as the electronic storage 13, electronic storage of a device accessible via a network, and/or other locations. The error component 110 may obtain error information from one or more engines dedicated to a particular function, such as the error engine 318, 422, 514 (shown in FIGS. 3, 4, and 5).

The error information for the website may define error status of the website. The error status of the website may refer to the state of errors on the website. The error status of the website may refer to whether or not errors have been detected on the website. The error status of the website may refer to errors that have been detected on the website. The error status of the website may refer to whether interaction with the website has been performed with or without error. For example, the error status of the website may indicate whether any errors have been depicted on the website. The error status of the website may indicate whether scraping of the website has been successfully performed or whether any errors were encountered during scraping of the website. The error status of the website may indicate whether interaction with the website (e.g., to complete a job application) website has been successfully performed or whether any errors were encountered during interaction with the website.

The error status of the website may include one or more unrecoverable errors, one or more recoverable errors, or other errors. A recoverable error may be associated with one or more elements of the website. For example, a recoverable error may be associated with one or more uncompleted parts of the website. For instance, a recoverable error may indicate that one or more required elements of the website have not been completed. A recoverable error may be associated with one or more network errors. For example, a recoverable error may be associated with a broken network connection and/or improper loading of the website.

Responsive to the error status of the website including the recoverable error associated with uncompleted part(s) of the website, one or more actions for the associated element(s) (e.g., uncompleted part(s)) of the website may be executed (by the execution component 112). For example, an error message may be generated based on a required field of the website being left blank. The error message may be associated with the blank, required field, and the blank, required field may be analyzed to determine actions to be taken for the blank, required field. The actions may be performed by the execution component 112 in an attempt to recover from the error. Responsive to the error status of the website including the recoverable error associated with network error(s), one or more of the actions for the content of the website may be re-executed, one or more additional actions for the content of the website may be executed, and/or the website may be reloaded. Responsive to the error status of the website including the unrecoverable error, interaction with the website may be stopped. For example, scraping of the website or interaction with the website (to complete a job application) may be stopped.

The error information may define the error status of the website by characterizing, describing, identifying, quantifying, reflecting, and/or otherwise defining the error status of the website. The error information may define the error status of the website by including information that defines one or more content, qualities, attributes, features, and/or other aspects of the error status of the website. The error information may define the error status of the website by including information that identifies types of errors and/or elements associated with errors. The error information may define the error status of the website by including information from which the types of errors and/or elements associated with errors may be determined. For example, the error information may include information on whether an error is a recoverable error or an unrecoverable error and information on element(s) associated with a recoverable error. Other types of error information are contemplated.

The execution component 112 may be configured to execute the actions for the content of the website. Executing the actions for the content of the website may include carrying out, putting into effect, facilitating, performing, and/or otherwise executing the actions for the content of the website. Executing the actions for the content of the website may include automatically interacting with the elements of the website. For example, the actions for the content of the website may be executed to automatically fill out a job application by automatically interacting with the elements of the website.

The actions for the content of the website may be executed based on the information associated with the user(s) and/or other information. The relevant information associated with user (e.g., general information, specific information) for the action may be identified based on the type of the action to be executed, the element for which the action is to be executed, the text, label, and/or the semantic associated with the elements, and/or other information.

The actions for the content of the website may be executed by identifying, loading, and/or running instructions corresponding to the actions. For example, different instructions may exist for filling in a text field versus clicking on a radio button. The instruction that is configured for the action to be performed may be identified, loaded, and/or run. The instruction may be modified and/or augmented using the information associated with the user. For example, for filling in a text field, instructions for filling a text field may be run with the instructions modified and/or augmented with information associated with the user that corresponds to the text, label, and/or the semantic of the text field. For example, a script of instructions for filling a text field may be run with a reference to the location in the database where the information to be filled in the text field is contained. The actions for the content of the website may be executed as described with respect to the interaction engine 314, 418 (shown in FIGS. 3 and 4), the execute actions 526 step (shown in FIG. 5), and/or the interaction components 600 (shown in FIG. 6).

In some implementations, the execution component may be configured to change the form of the information associated with the user(s) for use in interacting with the website. The form of the information associated with the user may refer to how the information associated with the user exists or appears. The form of the information associated with the user may refer to the arrangement of terms, phrases, and/or words in the information associated with the user. If the form of the information associated with the does not match the form of the information that is being requested/required by the website, the form of the information may be changed to match the form of the information being requested/required by the website. For example, one or more machine learning/AI models (e.g., large language model(s)) may be used to transform the information so that the transform form matches the form being requested/required while conveying the same underlying information. For example, machine learning/AI model(s) may be used to change the terms, phrases, and/or words of the information. For instance, a field of the website may require information on the user's bachelor's degree to be inserted. The information associated with the user may be stored using the term “university degree.” The information on the user's “university degree” may be transformed into words using the term “bachelor's degree” for interaction with the website. Other changes in the form of the information associated with the user are contemplated.

The actions for the content of the website may be executed on behalf of the user(s). The actions for the content of the website may be executed to facilitate the user(s)′ usage of the website. The actions for the content of the website may be executed to relieve the user(s) from the effort in interacting with the website. For example, the actions for the content of job websites may be executed to relieve a user from having to repeatedly answer the same/similar questions on different job websites. The actions for the content of job websites may be executed to relieve a user from having to interact with multiple websites.

The actions for the content of the website may be executed to mimic the user behavior in interacting with the website. Mimicking user behavior may include imitating, matching, replicating, simulating, and/or otherwise mimicking user behavior. Mimicking user behavior may include the actions for the content of the website being executed on behalf of the user. Mimicking user behavior may include executing the actions in a way that the user would perform the actions. Mimicking user behavior may include controlling the actions (e.g., which buttons are pressed, which options are selected, what information is entered) to match the actions that the user would perform. Mimicking user behavior may include controlling how the actions are performed to simulate the user interacting with the website. Mimicking user behavior may include the actions for the content of the website being executed imitating actions of a real person interacting with the content of the website. Mimicking user behavior may include modifying information that is provided to the website and/or controlling how/when the information is provided to the website to make it appear that the source of the information being provided to the website is a real person.

For example, a user interaction with the website may be simulated in the interaction of the system 10 with the website. Simulation of the user interaction with the website may include use of a proxy and a DDOS protection bypass to interact with the website; modification of browser information and/or user information for interacting with the website; and/or use of delays in and/or between the execution of the actions for the content of the website. Such control over how the system 10 interacts with the website may make the interaction appear to come from a real person. Simulation of the user interaction with the website may include use of one or more counter anti-bot technologies, such as described with respect to the interaction engine cycle 500 (shown in FIG. 5).

In some implementations, one or more execution reports for the website may be generated. The execution report(s) may include information on interaction of the system 10 with the website. The execution report(s) may include information on how the system 10 interacted with the website, the result of the interaction with the website, and/or other information about the interaction of the system 10 with the website. The execution report(s) may include information as described with respect to the execution report 558 (shown in FIG. 5), the execution report 900 (shown in FIG. 9), and/or the visualization 1000 of interaction with a webpage (Shown in FIG. 10). Other types of execution reports are contemplated.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible (non-transitory) computer-readable storage medium may include read-only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

In some implementations, some or all of the functionalities attributed herein to the system 10 may be provided by external resources not included in the system 10. External resources may include hosts/sources of information, computing, and/or processing and/or other providers of information, computing, and/or processing outside of the system 10.

Although the processor 11, the electronic storage 13, and the electronic display 14 are shown to be connected to the interface 12 in FIG. 1, any communication medium may be used to facilitate interaction between any components of the system 10. One or more components of the system 10 may communicate with each other through hard-wired communication, wireless communication, or both. For example, one or more components of the system 10 may communicate with each other through a network. For example, the processor 11 may wirelessly communicate with the electronic storage 13. By way of non-limiting example, wireless communication may include one or more of radio communication, Bluetooth communication, Wi-Fi communication, cellular communication, infrared communication, or other wireless communication. Other types of communications are contemplated by the present disclosure.

Although the processor 11, the electronic storage 13, and the electronic display 14 are shown in FIG. 1 as single entities, this is for illustrative purposes only. One or more of the components of the system 10 may be contained within a single device or across multiple devices. For instance, the processor 11 may comprise a plurality of processing units. These processing units may be physically located within the same device, or the processor 11 may represent processing functionality of a plurality of devices operating in coordination. The processor 11 may be separate from and/or be part of one or more components of the system 10. The processor 11 may be configured to execute one or more components by software; hardware; firmware; some combination of software, hardware, and/or firmware; and/or other mechanisms for configuring processing capabilities on the processor 11.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

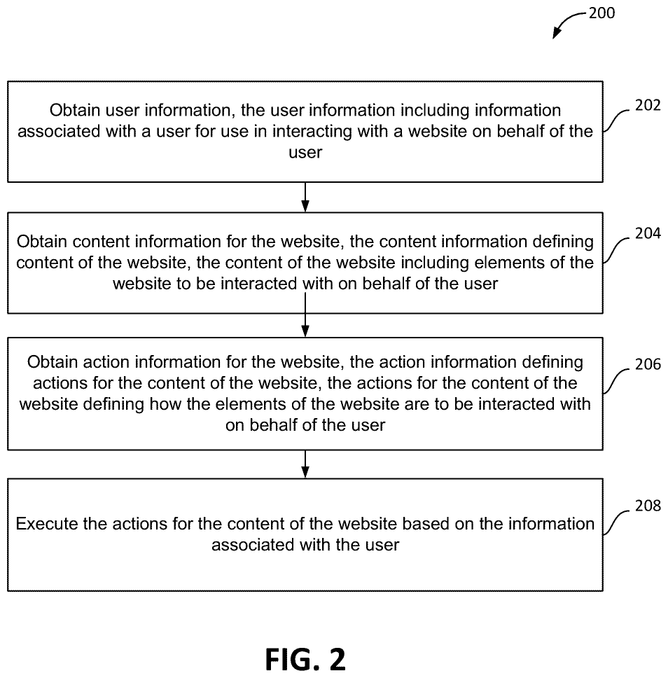

FIG. 2 illustrates method 200 for automatically interacting with web interfaces on behalf of users. The operations of method 200 presented below are intended to be illustrative. In some implementations, method 200 may be accomplished with one or more additional operations not described, and/or without one or more of the operations discussed. In some implementations, two or more of the operations may occur substantially simultaneously.

In some implementations, method 200 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operations of method 200 in response to instructions stored electronically on one or more electronic storage media. The one or more processing devices may include one or more devices configured through hardware, firmware, and/or software to be specifically designed for execution of one or more of the operations of method 200.

Referring to FIG. 2 and method 200, at operation 202, user information may be obtained. The user information may include information associated a user for use in interacting with the website on behalf of the user. In some implementations, operation 202 may be performed by a processor component the same as or similar to the user component 104 (Shown in FIG. 1 and described herein).

At operation 204, content information may be obtained. The content information for the website may define the content of the website. The content of the website may include elements of the website to be interacted with on behalf of the user. In some implementations, operation 204 may be performed by a processor component the same as or similar to the content component 106 (Shown in FIG. 1 and described herein).

At operation 206, action information may be obtained. The action information for the website may define actions for the content of the website. The actions for the content of the website may define how the elements of the website are to be interacted with on behalf of the user. In some implementations, operation 206 may be performed by a processor component the same as or similar to the action component 108 (Shown in FIG. 1 and described herein).

At operation 208, the actions for the content of the website may be executed based on the information associated with the user and/or other information. In some implementations, operation 208 may be performed by a processor component the same as or similar to the execution component 112 (Shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

1. A system for automatically completing job applications on websites with different structures, the system comprising:
one or more physical processors configured by machine-readable instructions to:
obtain user information, the user information including information associated with a user for use in interacting with a job website to complete a job application on behalf of the user;
execute cycles of operations to complete the job application on the job website, the cycles of operations enabling the job application to be completed on the job website regardless of structure of the job website, a single cycle of operations including:
obtaining content information for the job website, the content information defining elements of the job website to be interacted with on behalf of the user to complete the job application, the elements of the job website including a text field, a drop-down field, a radio button, a checkbox, an upload button, and/or an action button;
obtaining action information for the job website, the action information defining actions to be executed on the elements of the job website to complete the job application, the actions to be executed on the elements of the job website including value insertion into the text field, value selection from the drop-down field, clicking of the radio button, clicking of the checkbox, clicking of the upload button, and/or clicking of the action button of the job website; and
executing the actions on the text field, the drop-down field, the radio button, the checkbox, the upload button, and/or the action button of the job website based on the information associated with the user;
wherein:
at end of a single cycle of operations, error detection is used to determine whether the execution of the actions on the text field, the drop-down field, the radio button, the checkbox, the upload button, and/or the action button of the job website caused a change in the job website, the change in the job website including a new element appearing on the job website, wherein the error detection determines that the new element has appeared on the job website based on detection of an error message on the job website, the error message indicating that required interaction with the job website has not been performed, the error message associated with a changed part of the job website or appearing near in space to the changed part of the job website; and
responsive to determination that the execution of the actions on the text field, the drop-down field, the radio button, the checkbox, the upload button, and/or the action button of the job website caused the change in the job website, a new cycle of operations is executed for the change in the job website, wherein the new cycle of operations includes targeted analysis of the changed part of the job website that is associated with the error message or that is near in space to the error message to determine the new element of the job website and to determine an action to be executed on the new element of the job website.

2. (canceled)

3. The system of claim 1, wherein the one or more physical processors are further configured by the machine-readable instructions to:
obtain error information, the error information defining error status of the job website, the error status of the job website including an unrecoverable error or a recoverable error, the recoverable error associated with a network error for the job website;
responsive to the error status of the job website including the unrecoverable error, stop interaction with the job website; and
responsive to the error status of the job website including the recoverable error, re-execute one or more of the actions on the elements of the job website, execute one or more additional actions on the elements of the job website, and/or reload the job website.

4. The system of claim 1, wherein the one or more physical processors are further configured by the machine-readable instructions to:
obtain error information, the error information defining error status of the job website, the error status of the job website including an unrecoverable error or a recoverable error, the recoverable error associated with an uncompleted part of the job website;
responsive to the error status of the job website including the unrecoverable error, stop interaction with the job website; and
responsive to the error status of the job website including the recoverable error, execute one or more actions on the uncompleted part of the job website.

5. The system of claim 1, wherein the one or more physical processors are further configured by the machine-readable instructions to scrape the job website and interact with the elements of the job website to determine possible interactions with the elements of the job website.

6. The system of claim 1, wherein the elements of the job website to be interacted with on behalf of the user to complete the job application further include an input control.

7. The system of claim 1, wherein the elements of the job website to be interacted with on behalf of the user to complete the job application and the actions to be executed on the elements of the job website are determined based on analysis of source code and a screenshot of the job website.

8. (canceled)

9. The system of claim 1, wherein the one or more physical processors are further configured by the machine-readable instructions to request missing information from the user for use in interacting with the job website or change a form of the information associated with the user for use in interacting with the job website.

10. The system of claim 1, wherein the one or more physical processors are further configured by the machine-readable instructions to generate an execution report for the job website, the execution report including information on interaction of the system with the job website.

11. A method for automatically completing job applications on websites with different structures, the method performed by a computing system including one or more processors, the method comprising:
obtaining, by the computing system, user information, the user information including information associated with a user for use in interacting with a job website to complete a job application on behalf of the user;
executing, by the computing system, cycles of operations to complete the job application on the job website, the cycles of operations enabling the job application to be completed on the job website regardless of structure of the job website, a single cycle of operations including:
obtaining, by the computing system, content information for the job website, the content information defining elements of the job website to be interacted with on behalf of the user to complete the job application, the elements of the job website including a text field, a drop-down field, a radio button, a checkbox, an upload button, and/or an action button;
obtaining, by the computing system, action information for the job website, the action information defining actions to be executed on the elements of the job website to complete the job application, the actions to be executed on the elements of the job website including value insertion into the text field, value selection from the drop-down field, clicking of the radio button, clicking of the checkbox, clicking of the upload button, and/or clicking of the action button of the job website; and
executing, by the computing system, the actions on the text field, the drop-down field, the radio button, the checkbox, the upload button, and/or the action button of the job website based on the information associated with the user;
wherein:
at end of a single cycle of operations, error detection is used to determine whether the execution of the actions on the text field, the drop-down field, the radio button, the checkbox, the upload button, and/or the action button of the job website caused a change in the job website, the change in the job website including a new element appearing on the job website, wherein the error detection determines that the new element has appeared on the job website based on detection of an error message on the job website, the error message indicating that required interaction with the job website has not been performed, the error message associated with a changed part of the job website or appearing near in space to the changed part of the job website; and
responsive to determination that the execution of the actions on the text field, the drop-down field, the radio button, the checkbox, the upload button, and/or the action button of the job website caused the change in the job website, a new cycle of operations is executed for the new element of change in the job website, wherein the new cycle of operations includes targeted analysis of the changed part of the job website that is associated with the error message or that is near in space to the error message to determine the new element of the job website and to determine an action to be executed on the new element of the job website.

12. (canceled)

13. The method of claim 11, further comprising:
obtaining, by the computing system, error information, the error information defining error status of the job website, the error status of the job website including an unrecoverable error or a recoverable error, the recoverable error associated with a network error for the job website;
responsive to the error status of the job website including the unrecoverable error, stopping interaction with the job website; and
responsive to the error status of the job website including the recoverable error, re-executing one or more of the actions on the elements of the job website, executing one or more additional actions on the elements of the job website, and/or reloading the job website.

14. The method of claim 11, further comprising:
obtaining, by the computing system, error information, the error information defining error status of the job website, the error status of the job website including an unrecoverable error or a recoverable error, the recoverable error associated with an uncompleted part of the job website;
responsive to the error status of the job website including the unrecoverable error, stopping interaction with the job website; and
responsive to the error status of the job website including the recoverable error, executing one or more actions on the uncompleted part of the job website.

15. The method of claim 11, further comprising:
scraping, by the computing system, the job website; and
interacting, by the computing system, with the elements of the job website to determine possible interactions with the elements of the job website.

16. The method of claim 11, wherein the elements of the job website to be interacted with on behalf of the user to complete the job application further include an input control.

17. The method of claim 11, wherein the elements of the job website to be interacted with on behalf of the user to complete the job application and the actions to be executed on the elements of the job website are determined based on analysis of source code and a screenshot of the job website.

18. (canceled)

19. The method of claim 11, further comprising:
requesting, by the computing system, missing information from the user for use in interacting with the job website on behalf of the user; or
changing, by the computing system, a form of the information associated with the user for use in interacting with the job website.

20. The method of claim 11, further comprising generating, by the computing system, an execution report for the job website, the execution report including information on interaction of the computing system with the job website.

21. The system of claim 1, wherein:
the actions on the elements of the job website are executed via one or more of multiple interaction components, the multiple interaction components configured to support different actions and/or different elements;
the multiple interaction components are ordered in a list;
for a given action to be executed on a given element of the job website, the multiple interaction components are queried based on the ordering in the list to identify a given interaction component that supports the given action and/or the given element; and
the given action is executed on the given element via the identified interaction component.

22. The system of claim 21, wherein:
the multiple interaction components include a detection component, the detection component configured to support action and/or element not supported by other interaction components;
the detection component is listed last in the list; and
when a new interaction component is configured to support a new action and/or a new element, the new interaction component is listed above the detection component.

23. The method of claim 11, wherein:
the actions on the elements of the job website are executed via one or more of multiple interaction components, the multiple interaction components configured to support different actions and/or different elements;
the multiple interaction components are ordered in a list;
for a given action to be executed on a given element of the job website, the multiple interaction components are queried based on the ordering in the list to identify a given interaction component that supports the given action and/or the given element; and
the given action is executed on the given element via the identified interaction component.

24. The method of claim 23, wherein:
the multiple interaction components include a detection component, the detection component configured to support action and/or element not supported by other interaction components;
the detection component is listed last in the list; and
when a new interaction component is configured to support a new action and/or a new element, the new interaction component is listed above the detection component.
